(19) United States
(12) Patent Application Publication
(10) Pub. No.: US 2014/0304346 A1
(43) Pub. Date: Oct. 9, 2014

(54) METHOD AND APPARATUS FOR ASSIGNING CONVERSATION LEVEL IN PORTABLE TERMINAL

(71) Applicant: Samsung Electronics Co., Ltd., Gyeonggi-do (KR)

(72) Inventors: Hwayoung SONG, Seoul (KR); Eunsun KIM, Seoul (KR)

(73) Assignee: Samsung Electronics Co., Ltd., Gyeonggi-do (KR)

(21) Appl. No.: 14/243,226

(22) Filed: Apr. 2, 2014

(30) Foreign Application Priority Data
Apr. 3, 2013 (KR) 10-2013-0036342

(51) Int. Cl. H04L 12/58

(52) U.S. Cl. CPC H04L 51/04
USPC 709/206

(57) ABSTRACT

A method and apparatus for assigning a conversation level in a portable terminal is provided. The method for assigning a conversation level in a portable terminal includes entering, by a user of the portable terminal, a message in a chat window, comparing the message to be sent with a conversation level when the user inputs transmission for the message and updating the conversation level based on a result of the comparison, and sending the message and displaying the sent message on the chat window.

### PRIORITY

This application claims priority under 35 U.S.C. §119(a) to a Korean Patent Application filed on Apr. 3, 2013 in the Korean Intellectual Property Office and assigned Serial No. 10-2013-0036342, the entire disclosure of which is incorporated herein by reference.

### BACKGROUND

1. Field of the Invention

The present invention generally relates to a method and apparatus for assigning a conversation level in a portable terminal, and more particularly, to a method and apparatus for assigning a conversation level in a portable terminal, where a conversation that is a bundle of messages transmitted and received through the portable terminal is analyzed, a message according to an appropriate conversation level is recommended based on a conversation level, and a conversation level is detected through a User Interface (UI).

2. Description of the Related Art

The transmission and reception of SMS messages and chat messages in a portable terminal are common functions of the portable terminal, and text messages can be transmitted more rapidly as a touch screen has become common in portable terminals as an input device.

Wrong messages, however, are frequently transmitted due to the fast transmission of messages. Furthermore, a conversation may become awkward due to a mistakenly sent message because a message is sent without filtering the message or giving a warning, and even the relationship between persons may become awkward due to a mistakenly sent message.

Furthermore, when holding a conversation in a chat window, a message is commonly sent without filtering the message or giving a warning. However, it is necessary to filter a message depending on a subject to which the message will be transmitted or a subject of conversation when sending the message, or when a conversation is held. For example, there is a problem in that misunderstanding may occur if an informally written message is mistakenly sent to a superior officer within a company who has been mistaken to be a friend. Furthermore, misunderstanding may also occur if a formally written message is mistakenly set to the third party who has been mistaken to be a superior officer within a company.

Furthermore, a problem may occur due to attached documents if a message including the attached documents is mistakenly sent to a wrong recipient.

### SUMMARY

The present invention has been made to address at least the above described problems and disadvantages, and to provide at least the advantages described below. Accordingly, an aspect of the present invention provides a method and apparatus for assigning a conversation level in a portable terminal, which are capable of preventing a message from being mistakenly sent by assigning a level to a conversation.

Another aspect of the present invention provides a method and apparatus for assigning a conversation level in a portable terminal, wherein a message can be prevented from being mistakenly sent and can be conveniently entered if a selected word is used because a recommendation word suitable for a level of a conversation is provided.

Another aspect of the present invention provides a method and apparatus for assigning a conversation level in a portable terminal, wherein a sentence of a conversation is analyzed, a conversation level is assigned to the conversation based on a result of the analysis, the assigned conversation level continues to be managed, and a proper conversation level is managed by setting the conversation level upward or downward.

In accordance with an aspect of the present invention, a method for assigning a conversation level in a portable terminal includes entering, by a user of the portable terminal, a message in a chat window, comparing the message to be sent with a conversation level when the user inputs transmission for the message and updating the conversation level based on a result of the comparison, and sending the message and displaying the sent message on the chat window.

In accordance with another aspect of the present invention, an apparatus for assigning a conversation level in a portable terminal includes a display unit for differently displaying a Graphic User Interface (GUI) of a chat window according to the conversation level, a memory unit for storing a conversation level of a conversation according to the chat window in the portable terminal and storing the metadata of the conversation level, and a control unit for providing a recommendation word suitable for the conversation level, updating the conversation level in order to set the conversation level upwardly or downwardly when the conversation level is changed by a specific number or more, comparing a conversation level of a message to be sent with the conversation level, querying a user whether or not to send the message if, as a result of the comparison, the conversation level of the message is found to be not suitable for the conversation level, and sending the message based on a result of the query.

### BRIEF DESCRIPTION OF THE DRAWINGS

The foregoing and other aspects, features and advantages of the present invention will become more apparent from the following detailed description when taken in conjunction with the accompanying drawings in which:

FIG. 1 is a block diagram schematically showing the construction of a portable terminal for assigning a conversation level in accordance with an embodiment of the present invention;

FIGS. 2A and 2B are flowcharts illustrating a process of assigning a conversation level in the portable terminal in accordance with an embodiment of the present invention;

FIG. 3 is a flowchart illustrating a process of comparing messages with each other and updating a level based on a result of the comparison in the flowchart of FIG. 2 of the present invention;

FIG. 4 is a flowchart illustrating a process of downward setting a conversation level in the flowchart of FIG. 3 of the present invention; and

FIG. 5 is a flowchart illustrating a process of upward setting a conversation level in the flowchart of FIG. 3 of the present invention.

### DETAILED DESCRIPTION OF EMBODIMENTS OF THE PRESENT INVENTION

Hereinafter, embodiments of the present invention are described in detail with reference to the accompanying drawings. It is to be noted that the same reference numbers are used throughout the drawings to refer to the same elements. Furthermore, a detailed description of known functions or constructions that may make the gist of the invention vague is omitted.

The embodiments disclosed in the present specification and drawings are illustrated to present only specific examples in order to clarify the technical contents of the invention and help understanding of the invention, but are not intended to limit the scope of the present invention. It will be evident to those skilled in the art that various implementations based on the technical spirit of the present invention are possible in addition to the disclosed embodiments.

Herein, a “message” means data formed of text and means text data that is transmitted at a time. Accordingly, a message may include from one icon or word to a plurality of sentences.

A “conversation” means a bundle of messages that are exchanged between specific persons or specific groups.

A “conversation level” means a level of conversation formality. For example, a conversation style, such as ‘hearache’ (i.e., the formal, non-polite speech level in Korean), ‘hageche’ (i.e., the familiar style, speech level of neutral politeness in Korean), ‘haoche’, ‘hapsyoche’ (i.e., the formal, polite speech level in Korean), ‘haeche’ (i.e., the informal, non-polite speech level in Korean), or ‘haeyoche’ (i.e., the informal, polite speech level in Korean), may be used depending on a chat partner or a chat group. However, it is to be noted that the aforementioned styles of speech are classified based on only the ends of words in order to illustrate conversation levels, but conversation levels are not classified based on only the ends of words.

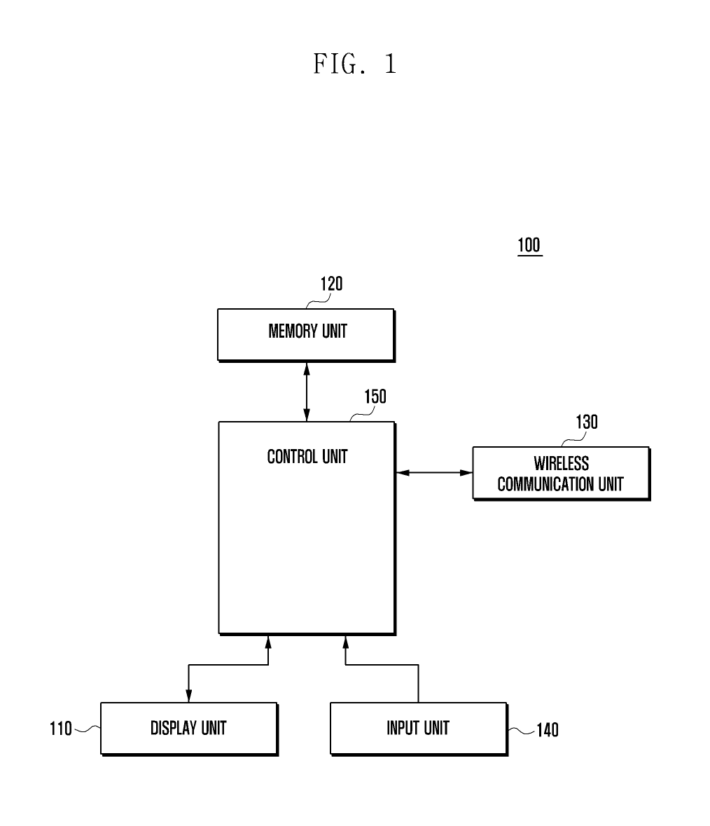

FIG. 1 is a block diagram schematically showing the construction of a portable terminal for assigning a conversation level in accordance with an embodiment of the present invention. Referring to FIG. 1, the portable terminal 100 includes a display unit 110, a memory unit 120, a wireless communication unit 130, an input unit 140, and a control unit 150.

The portable terminal 100 may further include an audio module for outputting various audio data that needs to be outputted in the operation of the portable terminal 100 and a camera module for a photograph/moving image capturing function. Herein, the audio module and the camera module are not described and shown, for simplicity.

The display unit 110 provides screens in which applications supporting the portable terminal 100 are executed. For example, the display unit 110 can display screens in which a file display function, a file search function, a message function, an e-mail function, an Internet function, a multimedia function, a photo view function, and a music playback function are executed. A device including a display device, such as a Liquid Crystal Display (LCD) or Organic Light Emitting Diodes (OLEDs), may be used as the display unit 110.

The display unit 110 can also display different Graphic User Interfaces (GUI) in response to a conversation level. For example, when a chat window is displayed in a deep red color, it may mean that the chat window is a chat window having a high conversation level. When a chat window is displayed in a light red color, it may mean that the chat window is a chat window having a low conversation level. That is, the display unit 110 may configure a chat window by controlling the depth of color so that a conversation level is intuitively distinguished. In an embodiment, the display unit 110 may configure a chat window to be is displayed as having a high conversation level when it is displayed in color close to blue and configure a chat window to be is displayed as having a low conversation level when it is displayed in color close to red, and vice versa. Furthermore, the display unit 110 may display a conversation level on top of a chat window in the form of a message or display a semi-transparent message, corresponding to a conversation level, within a chat window.

Furthermore, the display unit 110 can display an appropriate recommendation word in response to a conversation level. The display unit 110 can display a message or a conversation. If the display unit 110 operates as a touch screen, the display unit 110 performs an input function for entering a message and sending the entered message. If a conversation level is not appropriate, the display unit 110 can display a message that asks whether or not to send the message without change. The control unit 150 may send the message without change, cancel the transmission of the message, or delete the message in response to user input.

The memory unit 120 stores various programs and data that are executed and processed by the portable terminal 100 and includes one or more volatile memory devices, for example, a DRAM, and a non-volatile memory device, for example, a flash memory. The memory unit 120 includes the Operating System (OS) of the portable terminal 100.

Furthermore, the memory unit 120 in accordance with the present invention stores conversations and conversation levels or default conversation levels that are analyzed according to stored conversations, or that are designated by a user. When a conversation level is stored, conversation contents, and information about each of the members of a group who have participated in the conversation (that is, information about message recipients, a date, and time) can also be stored as metadata. Here, if a chat name or a group name is present in a chat window, the chat name or the group name may also be added to the metadata.

The wireless communication unit 130 is configured in the form of a mobile communication module which can form a communication channel with a base station in order to support the communication function of the portable terminal 100. The wireless communication unit 130 supports a function of receiving a file, together with a message, from the outside under the control of a user or based on predetermined schedule information. The wireless communication unit 130 also supports a function of sending a message entered in the portable terminal 100 or files or information, collected by the portable terminal 100, to the outside. The wireless communication unit 130 may include a communication module that supports a short-distance communication function. The wireless communication unit 130 supports a function of sending a message or a file by forming a short-distance communication channel with another terminal through the communication module.

The input unit 140 is configured to generate various input signals for the operation of the portable terminal 100. The input unit 140 includes a home key, a side key, a menu key, and a back key. The input unit 140 may be formed of various input means, such as a keyboard, a keypad, or a key button, depending on whether the portable terminal 100 is compatible or not. Accordingly, various types of input, such as entering and sending a message, can be performed through the various input means.

The control unit 150 generally controls the portable terminal 100. The control unit 150 can analyze a conversation, determine a conversation level of the conversation, and update the conversation level.

The control unit 150 can analyze the contents of a received message, assign a conversation level to the conversation, and suggest a recommendation word suitable for the conversation level. For example, when ‘Hi’ is entered in a chat window having a high conversation level, the control unit 150 may recommend ‘How are you!’ as a recommendation word. The control unit 150 manages the memory unit 120 for updating a conversation level. If a change in a conversation level is of a specific number or greater, the control unit 150 may perform level update. Accordingly, the conversation level is updated when the number of change in the level, from the currently specified conversation level, is equal to or greater than a specific number.

The control unit 150 compares a conversation level of a message to be sent with a conversation level. If, as a result of the comparison, the conversation level of the message is found to be not suitable for the conversation level, the control unit 150 then determines the conversation level of the message to be sent in order for a user to check the message before the transmission of the message or while the message is entered.

If the entered message is within a permissible range as a result of a comparison between a level of the entered message and a conversation level of a chat window, the control unit 150 controls a message indicating whether or not the entered message has been sent so that the message is not displayed.

If a conversation level of a conversation message is updated, the control unit 150 updates the conversation level by assigning weight to the conversation message. For example, if a most honorary term is used, a higher weight for an upward setting a conversation level may be selected. If slang is used, a higher weight for a downward setting a conversation level may be selected.

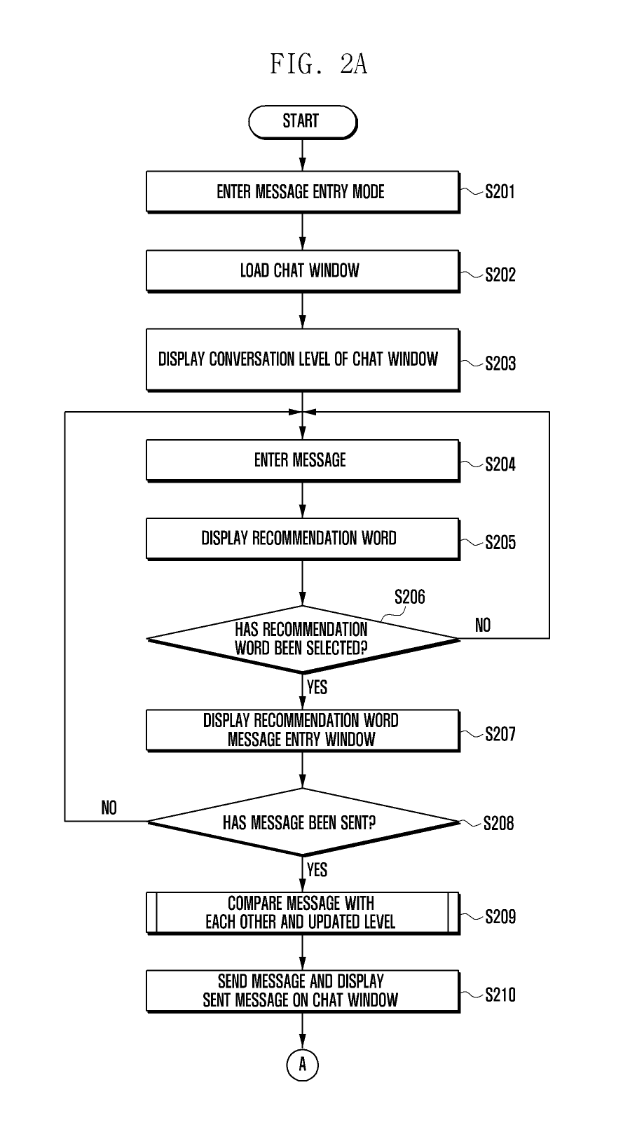

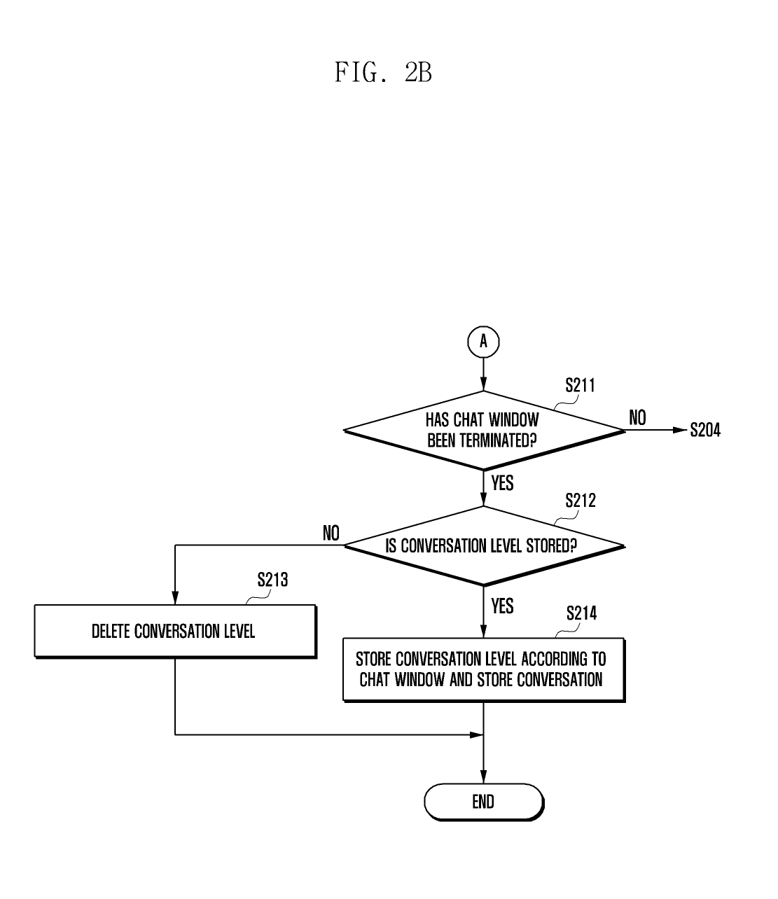

FIGS. 2A and 2B are flowcharts illustrating a process of assigning a conversation level in the portable terminal in accordance with an embodiment of the present invention. Referring to FIG. 2, the user of the portable terminal 100 enters a message entry mode by executing a chat application or an application for sending a message, such as a message chat window or other Social Networking Service (SNS), at step S201.

The user loads a chat window through a process of selecting a chat partner or a chat group at step S202. In relation to a conversation level for the chat partner, a conversation level that has been previously stored may be fetched depending on the settings and displayed as the conversation level for the chat partner in a different chat window. If a chat window is closed, a conversation level may be deleted. If a conversation level is deleted, a conversation level having a default value may be assigned. If a conversation level having a default value is classified into ‘very difficult’, ‘difficult’, ‘normal’, ‘intimate’, and ‘very intimate’, ‘normal’ may be the default conversation level. In another embodiment, if a conversation level having a default value is classified into ‘good’, ‘fair’, and ‘poor’, ‘fair’ may be the default conversation level. If a conversation level is deleted, a user may directly set a conversation level, or the control unit 150 may automatically assign a conversation level when messages are accumulated.

The control unit 150 displays a conversation level of the chat window according to the set conversation level at step S203. The control unit 150 can display the edge of the chat window in a different color depending on a conversation level. In an embodiment, the conversation level of the chat window may be displayed on top of the chat window in a text form or may be semi-transparently displayed within the chat window in a text form.

The user enters a message in the input window of the chat window at step S204. The control unit 150 displays a recommendation word in response to the entered message at step S205. The recommendation word may be displayed on a region other than the message input window, for example, on top of the message input window. For example, when ‘Hi’ is entered in a chat window having a high conversation level, ‘How are you!’ may be displayed as a recommendation word. In contrast, when ‘How are you!’ is entered in a chat window having a low conversation level, a message ‘Hi’ may be recommended.

The control unit 150 determines whether the user has selected the word, recommended at step S205, at step S206. If, as a result of the determination at step S206, the user has selected the recommended word, the control unit 150 displays the recommended word message on the message input window at step S207. If, as a result of the determination at step S206, the user has not selected the recommended word message, the control unit 150 returns to step S204 in which a message is entered.

The control unit 150 then determines whether input for sending the message has been received from the user at step S208. If, as a result of the determination at step S208, any input for sending the message has not been received from the user, the control unit 150 returns to step S204 in which a message is entered.

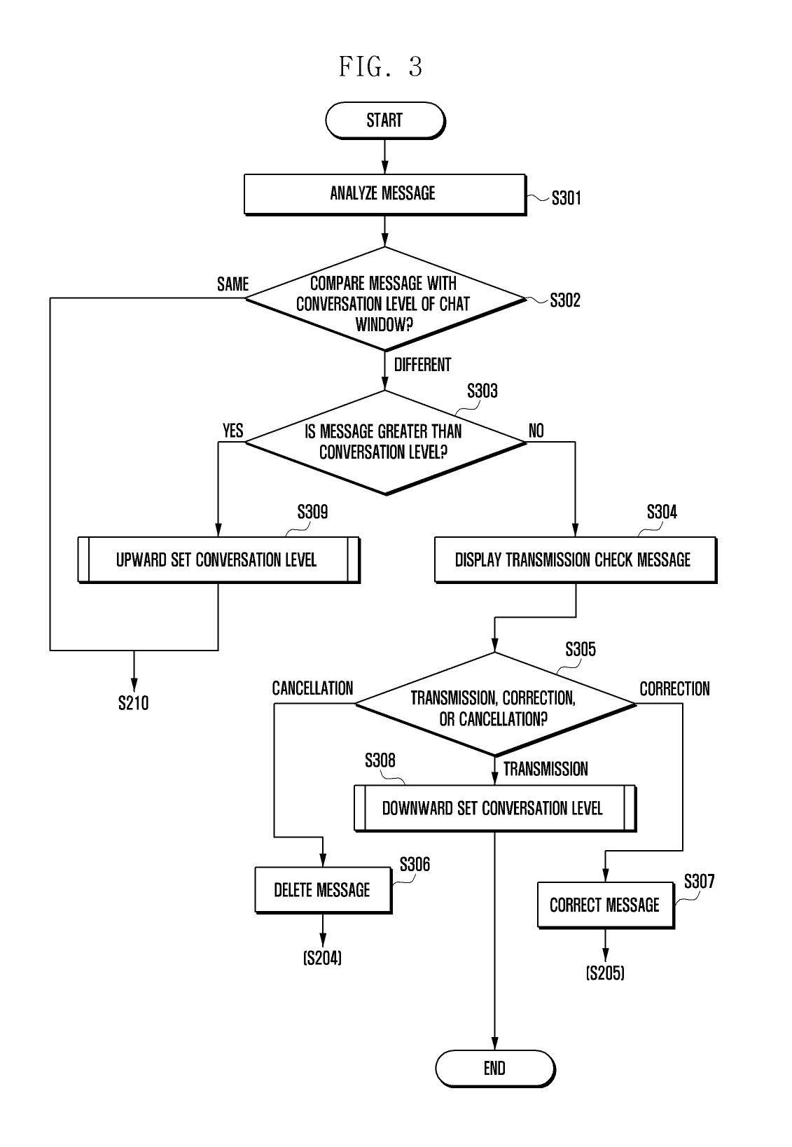

If, as a result of the determination at step S208, input for sending the message has been received from the user, the control unit 150 compares the message to be sent with the conversation level at step S209 and updates the conversation level based on a result of the comparison. Meanwhile, step S209 is described in more detail below with reference to FIG. 3.

The control unit 150 sends and displays the message through the chat window at step S210.

The control unit 150 then determines whether the user terminates the chat window at step S211. If, as a result of the determination at step S211, the user does not terminate the chat window, the control unit 150 returns to step S204 in which a message is entered.

If, as a result of the determination at step S211, the user terminates the chat window, the control unit 150 determines whether to store the conversation level at step S212. A determination of the storage of the conversation level of the chat window may be automatically made depending on the settings. If a chat window is closed, a conversation level may or not be stored depending on such setting. In an embodiment, if a chat window is terminated, a user may be queried as to whether to store a conversation level, and the conversation level may or may not be stored based on a result of the query.

If, as a result of the determination at step S212, the conversation level is determined to not be stored, the control unit 150 deletes the conversation level at step S213. If a chat window is opened with the same chat partner or the same chat group after the conversation level is deleted, a conversation level having a default value may be assigned to the chat window, or a different conversation level may be assigned to the chat window as messages are accumulated without assigning a default conversation level.

If, as a result of the determination at step S212, the conversation level is determined to be stored, the control unit 150 stores a level according to the chat window, that is, a conversation level according to a chat partner or a chat group at step S214. When storing the conversation level, conversation contents, information such as dates when the chat window was opened and closed, and chat partners who had participated in the chat window, may also be stored as metadata.

FIG. 3 is a flowchart illustrating a process of comparing messages with each other and updating a level based on a result of the comparison in the flowchart of FIG. 2 of the present invention. Referring to FIG. 3, the control unit 150 analyzes the message at step S301. The message may be analyzed using text mining, rule-based reasoning, or case-based reasoning.

The control unit 150 compares the analyzed message with a conversation level of a current chat window at step S302. Here, the conversation level of the chat window may be a conversation level previously assigned to a group if a subject of the chat window is a group conversation or a group chat, and may be a conversation level that is set depending on a chat partner if a subject of the chat window is a 1:1 conversation.

At step S302, the control unit 150 determines whether the analyzed message has the same conversation level as the chat window or has a different conversation level from the chat window by comparing the analyzed message with the conversation level of the chat window.

If, as a result of the comparison at step S302, the analyzed message is found to have the same conversation level as the chat window, the control unit 150 proceeds to step S210 in which the message is sent.

Here, a permissible range may be assigned to the message, and the message can be transmitted if the message falls within a permissible range permitted by the chat window although the message has a different conversation level from the chat window. If a message falls within a permissible range of a conversation level, the conversation level may not be changed.

If, as a result of the comparison at step 302, the analyzed message is found to have a different conversation level from the chat window, that is, the analyzed message does not fall within a permissible range, the control unit 150 determines whether the analyzed message has a higher conversation level than the chat window at step S303.

If, as a result of the comparison at step 303, the analyzed message is found to have the same conversation level as or a lower conversation level than the chat window, the control unit 150 displays a transmission check message at step S304. In the transmission check message, transmission, correction, or cancellation of the analyzed message may be selected.

The control unit 150 determines that the user has selected which one of the transmission, correction, and cancellation of the analyzed message in the transmission check message at step S305.

If, as a result of the determination at step S305, the user has selected to cancel the transmission of the analyzed message, the control unit 150 deletes the analyzed message at step S306 and proceeds to step S204 in which a message is entered. If, as a result of the determination at step S305, the user has selected to correct the analyzed message, the control unit 150 corrects the analyzed message at step S307 and proceeds to step S205 in which a recommendation word for the corrected message is displayed.

If, as a result of the determination at step S305, the user has selected to transmit the analyzed message, the control unit 150 downwardly sets the conversation level at step S308 and proceeds to step S210 in which the message is sent.

Referring back to step S303, if, as a result of the comparison at step 303, the analyzed message is found to have a higher conversation level than the chat window, the control unit 150 upwardly sets the conversation level at step S309 and proceeds to step S210 in which the message is sent.

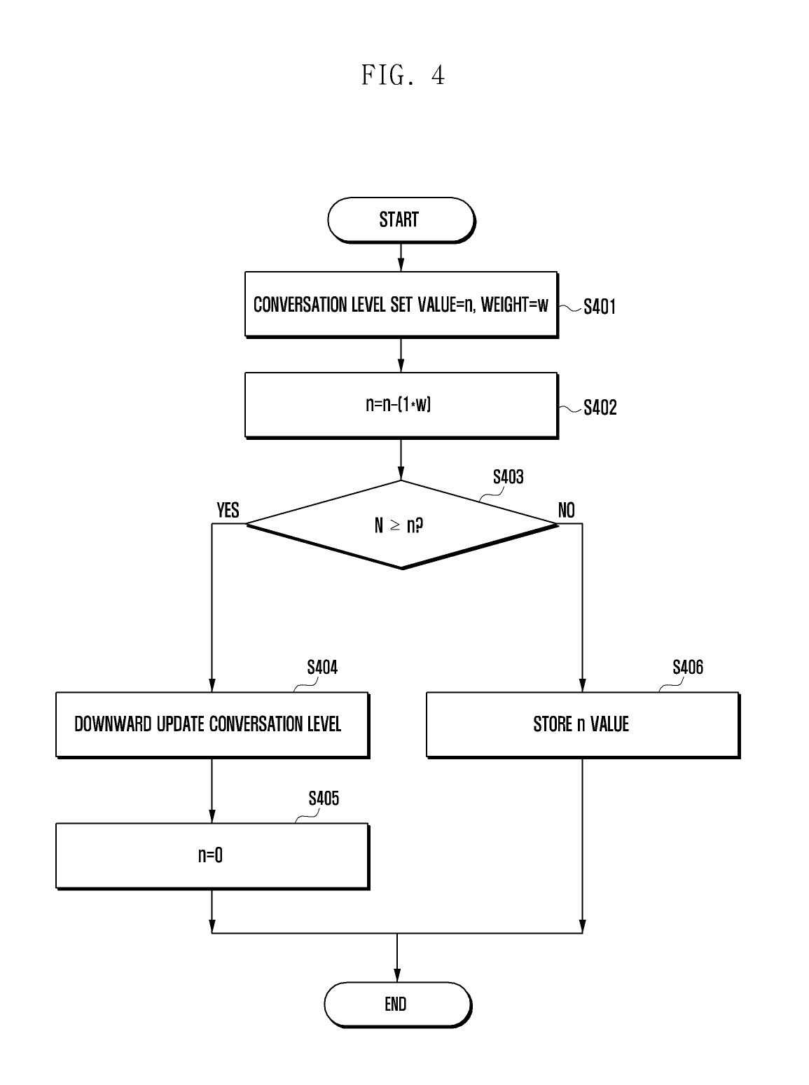

FIG. 4 is a flowchart illustrating a process of downwardly setting a conversation level in the flowchart of FIG. 3 of the present invention. Referring to FIG. 4, the control unit 150 sets ‘n’ as a conversation level set value and ‘w’ (w is a natural number) as a weight at step S401.

The control unit 150 subtracts 1 from the conversation level set value ‘n’ at step S402. Here, if the weight has been attached to a message, 1 is multiplied by the weight, and a result of the multiplication is subtracted from the conversation level set value ‘n’. If the weight has not been attached to the message, the weight is set to 1. This may be represented by Equation (1) below, for example.

n=n−(1*w) (1)

The weight may be set in the message by analyzing the end of a word or words or comprehensively analyzing the message when analyzing the message at step S301 of FIG. 3. For example, assuming that the conversation level is classified into 5 types: ‘very difficult’, ‘difficult’, ‘normal’, ‘intimate’, and ‘very intimate’, if a ratio of slang not suitable for the conversation level ‘difficult’ is high in the words of a message in a chat group set as the conversation level ‘difficult’, and a message is written in ‘plain style’ not suitable for the end of a word ‘difficult’, a ratio where the conversation level set value ‘n’ is subtracted may be increased by setting the weight ‘w’ to 2 or more.

The control unit 150 determines whether a downward threshold N is greater than or equal to the conversation level set value ‘n’ changed in accordance with Equation (1) at step S403. The downward threshold N may be a minus integer value smaller than −1. The downward threshold N may be set to an integer value less than −4.

If, as a result of the determination at step S403, the downward threshold N is greater than or equal to the conversation level set value ‘n’, the control unit 150 updates the conversation level by downwardly setting the conversation level at step S404.

The control unit 150 resets the conversation level set value ‘n’ to 0 (i.e., n=0) at step S405.

If, as a result of the determination at step S403, the downward threshold N is less than the conversation level set value ‘n’, the control unit 150 stores the conversation level set value ‘n’ at step S406. An example in which the conversation level set value ‘n’ is stored at step S406 has been described, but the conversation level may be stored or deleted if a chat window is closed as described above with reference to FIG. 2. In particular, if the conversation level is deleted at step S213, the conversation level set value ‘n’ may also be deleted.

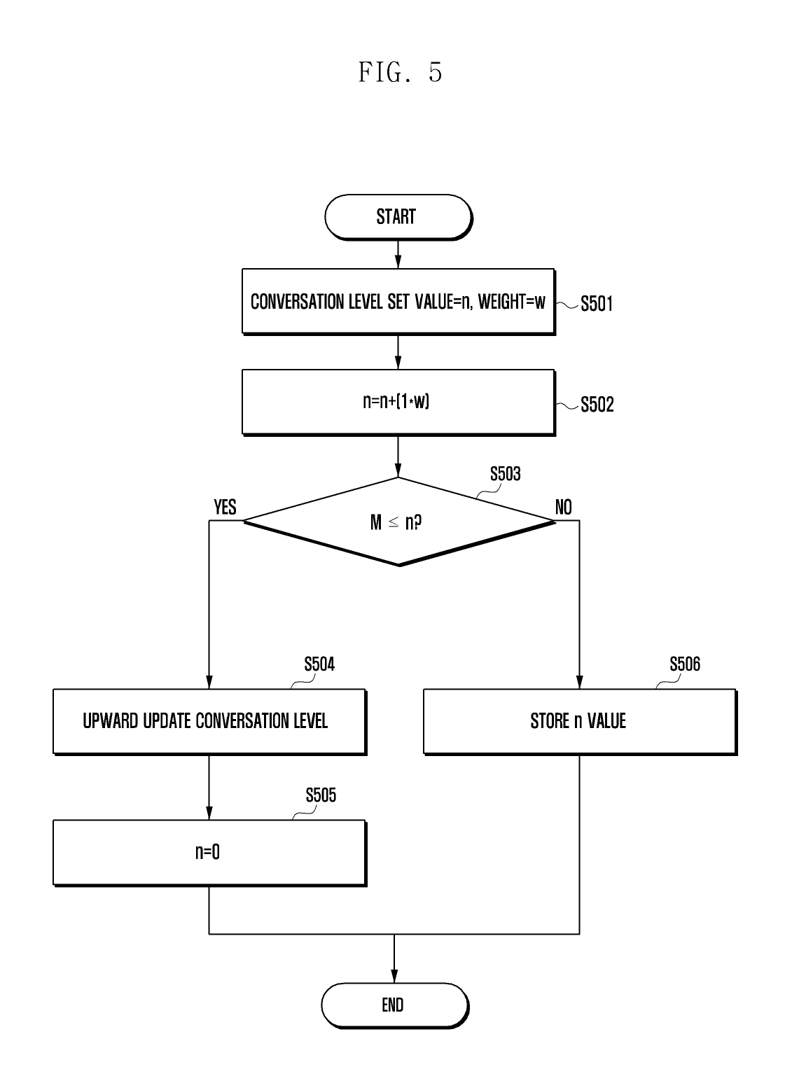

FIG. 5 is a flowchart illustrating a process of upwardly setting a conversation level in the flowchart of FIG. 3 of the present invention. Referring to FIG. 5, the control unit 150 sets ‘n’ as a conversation level set value and ‘w’ (w is a natural number) as weight at step S501. A conversation level can be changed when the conversation level set value ‘n’, that is, a value necessary to update the conversation level, becomes a specific value or more or becomes less than a specific value.

The control unit 150 increases the conversation level set value ‘n’ by 1 at step S502. Here, if the weight ‘w’ has been attached to a message, 1 is multiplied by the weight, and a result of the multiplication is increased. If the weight ‘w’ has not been attached to the message, the weight is set to 1. This may be represented by Equation (2) below, for example.

n=n+(1*w) (2)

The weight may be set in the message by analyzing the end of a word or words or comprehensively analyzing the message when analyzing the message at step S301 of FIG. 3. For example, assuming that the conversation level is classified into 3 types: ‘very good’, ‘fair’, and ‘poor’, if a ratio of honorary terms not suitable for the conversation level ‘poor’, is high in the words of a message in a chat group set as the conversation level ‘poor’, and a message is written in ‘differential style’ not suitable for the end of a word ‘poor’, a ratio where the conversation level set value ‘n’ is increased may be increased by setting the weight ‘w’ to 2 or more.

The control unit 150 determines whether the conversation level set value ‘n’ changed in accordance with Equation (2) is greater than or equal to an upward threshold M at step S503. The upward threshold M may be a natural value greater than 1. The upward threshold M may be set to a natural value greater than 4.

If, as a result of the determination at step S503, the conversation level set value ‘n’ is greater than or equal to the upward threshold M, the control unit 150 updates the conversation level by upwardly setting the conversation level at step S504.

The control unit 150 resets the conversation level set value ‘n’ to 0 (i.e., n=0) at step S505.

If, as a result of the determination at step S503, the conversation level set value ‘n’ is less than the upward threshold M, the control unit 150 stores the conversation level set value ‘n’ at step S506.

The conversation level set value ‘n’ shown in FIG. 5 may be the same as the conversation level set value ‘n’ shown in FIG. 4 or may have a different value that is additionally managed. For example, if the conversation level set values of FIGS. 4 and 5 are different from each other, an upward conversation level set value and a downward conversation level set value may be separately counted. If one of the two conversation level set values is a threshold or more or less than the threshold or both the conversation level set values have the same value, both upper and lower conversation level set values are reset to 0. That is, both the upper and lower conversation level set values may be stored.

As described above, the method and apparatus for assigning a conversation level in the portable terminal in accordance with the present invention have an advantage in that an intended message can be sent to a desired partner more accurately because a message is prevented from being mistakenly sent by assigning a conversation level to a conversation.

Furthermore, the present invention is advantageous in that a user can be prevented from mistakenly sending a message because a recommendation word suitable for a conversation level is provided to the user and a user can enter a message conveniently and send the message because the user selects a recommendation word.

Furthermore, in accordance with the present invention, a conversation level is assigned to a conversation by analyzing a sentence of the conversation, and a proper conversation level is managed by setting a conversation level upwardly or downwardly based on an assigned conversation level. The method and apparatus for assigning a conversation level in a portable terminal in accordance with embodiments of the present invention have been described above through the specification and drawings. Although specific terms are used, the terms are merely used according to their common meanings in order to easily describe the technical aspects of the present invention and help in understanding the invention, and the present invention is not limited to the aforementioned embodiments. That is, it will be evident to those skilled in the art that various embodiments can be implemented without departing from the technical spirit and scope of the present invention, as defined by the claims and their equivalents.

What is claimed is:

1. A method for assigning a conversation level in a portable terminal, the method comprising:
entering, by a user of the portable terminal, a message in a chat window;
comparing the message to be sent with a conversation level when the user provides an input for transmission of the message and updating the conversation level based on a result of the comparison; and
sending the message and displaying the sent message on the chat window.

2. The method of claim 1, further comprising displaying a conversation level suitable for the conversation level of the chat window when the chat window is loaded in the portable terminal, before displaying the sent message on the chat window.

3. The method of claim 2, further comprising:
displaying a recommendation word according to the entered message and the conversation level after entering the message in the chat window; and
displaying the recommendation word on a message input window when the recommendation word is selected.

4. The method of claim 1, further comprising:
determining whether to terminate the chat window after displaying the sent message on the chat window;
determining whether to store the conversation level of the chat window if, as a result of determining whether to terminate the chat window, the chat window is determined to be terminated;
storing the conversation level of the chat window and metadata if, as a result of determining whether to store the conversation level, the conversation level of the chat window is determined to be stored; and
deleting the conversation level of the chat window if, as a result of determining whether to store the conversation level, the conversation level of the chat window is determined to be not stored.

5. The method of claim 4, further comprising designating a conversation level to a chat window identical to the terminated chat window by either designating a conversation level having a default value to the identical chat window or designating a conversation level according to accumulated messages without designating a conversation level to the identical chat window, if the identical chat window is opened after the deleting of the conversation level of the chat window.

6. The method of claim 4, wherein the metadata comprises at least one of conversation contents, a date when the chat window was opened, a date when the chat window was closed, and information about chat partners who have participated in the chat window.

7. The method of claim 4, wherein determining whether to store the conversation level of the chat window comprises automatically determining whether to store the conversation level of the chat window according to a conversation level set in the portable terminal, or querying the user as to whether to store the conversation level of the chat window and determining whether to store the conversation level of the chat window in response to input from the user.

8. The method of claim 2, wherein displaying the conversation level suitable for the conversation level of the chat window comprises differently displaying the chat window according to the conversation level.

9. The method of claim 8, wherein differently displaying the chat window according to the conversation level comprises one of displaying a color of the chat window differently, displaying a depth of the color differently, displaying the conversation level of the chat window on top of the chat window, or displaying the conversation level of the chat window within the chat window in a text form.

10. The method of claim 1, wherein updating the conversation level based on the result of the comparison comprises:
analyzing the message;
comparing the analyzed message with the conversation level of the chat window;
determining whether the analyzed message has a higher conversation level than the chat window if, as a result of the comparison, the analyzed message is found to have a different conversation level from the chat window;
displaying a transmission check message that queries whether to send the analyzed message if, as a result of the determination, the analyzed message is determined to have a conversation level less than or equal to the conversation level of the chat window;
downwardly setting the conversation level if transmission of the analyzed message is checked in displaying the transmission check message; and
upwardly setting the conversation level if, as a result of the determination, the analyzed message is determined to have a higher conversation level than the chat window.

11. The method of claim 10, further comprising sending the analyzed message either if the analyzed message has a conversation level identical with the conversation level of the chat window or if the analyzed message falls within a permissible range of a conversation level allowed in the chat window, even though the analyzed message has a different conversation level from the chat window.

12. The method of claim 10, wherein downwardly setting the conversation level comprises:
setting a predetermined conversation level set value and weight;
subtracting a result value, obtained by multiplying 1 by the weight, from the conversation level set value;
determining whether the result value is less than or equal to a predetermined downward threshold;
updating the conversation level by downwardly setting the conversation level if, as a result of the determination, the conversation level set value is determined to be less than or equal to the predetermined downward threshold; and
resetting the conversation level set value.

13. The method of claim 12, further comprising storing the conversation level set value if, as a result of the determination, the conversation level set value is determined to be greater than the predetermined downward threshold.

14. The method of claim 10, wherein upwardly setting the conversation level comprises:
setting a predetermined conversation level set value and weight;
increasing a result value, obtained by multiplying 1 by the weight, from the conversation level set value;
determining whether the result value is greater than or equal to a predetermined upward threshold;
updating the conversation level by upwardly setting the conversation level if, as a result of the determination, the conversation level set value is determined to be greater than or equal to the predetermined upward threshold; and
resetting the conversation level set value.

15. The method of claim 14, further comprising storing the conversation level set value if, as a result of the determination, the conversation level set value is determined to be less than the predetermined upward threshold.

16. An apparatus for assigning a conversation level in a portable terminal, comprising:
a display unit for differently displaying a Graphic User Interface (GUI) of a chat window according to the conversation level;
a memory unit for storing a conversation level of a conversation according to the chat window in the portable terminal and storing metadata of the conversation level; and
a control unit for configured to provide a recommendation word suitable for the conversation level, update the conversation level in order to set the conversation level upwardly or downwardly when the conversation level is changed by a specific number or more, compare a conversation level of a message to be sent with the conversation level, query a user whether to send the message if, as a result of the comparison, the conversation level of the message is found to be not suitable for the conversation level, and send the message based on a result of the query.
